(19) United States
(12) Patent Application Publication
(10) Pub. No.: US 2007/0075126 A1
(43) Pub. Date: Apr. 5, 2007

(54) Identification method and system

(75) Inventors: Chi Wei Fu, Taipei (TW); Sung Pin Wang, Taipei (TW)

Correspondence Address: QUINTERO LAW OFFICE, PC, 2210 MAIN STREET, SUITE 200, SANTA MONICA, CA, 90405, US

(73) Assignee: WISTRON CORP., TAIPEI HSIEN (TW)

(21) Appl. No.: 11/484,505

(22) Filed: Jul. 10, 2006

(30) Foreign Application Priority Data
Sep. 30, 2005 (TW) TW94134208

(51) Int. Cl. G06F 17/00

(52) U.S. Cl. 235/375

(57) ABSTRACT

An identification system comprising a first electronic device having a first receiving part, a connection cable suited for the first electronic device, a second electronic device and an identification unit is provided. The connection cable further comprises a first connection part to connect the first receiving part and a second connection part having a first pin, a second pin and a plurality of identification pins coupled to the first pin or the second pin. The second electronic device comprises a second receiving part and an identification unit. The second receiving for connecting to the second connection part comprises a first pin receiving part for connecting the first pin, a second pin receiving part for connect the second pin and a plurality of identification pin receiving parts for connect the identification pins. The identification unit is coupled to the identification pin receiving parts, wherein when the first connection part is electrically connected to the first receiving part and the second connection part is electrically connected to the second receiving part, the identification unit transmits an identification data to the second electronic device according to the logic states of the identification pin receiving parts, and the second electronic device drives the first electronic device according to the identification data.

### BACKGROUND OF THE INVENTION

1. Field of the Invention

The present invention relates to an identification method and system, and more particularly to an identification method and system between two electronic devices.

2. Description of the Related Art

An identification device is required to identify electronic devices of the same type but having different specifications, wherein each type has an electronic devices classification, such as liquid crystal display (LCD), keyboard, mouse, and the like, and the different specifications indicates a particular limitation of the electronic device, such as the specification VGA, XVGA, SVGA of the LCD. Take an LCD panel for example. A dip switch or other means is used to identify various types of different panels. Please refer to FIG. 1a. FIG. 1a is a schematic diagram of a conventional identification system. The panel 10 is electrically connected to the motherboard 12 via a connection cable (not shown in FIG. 1a), wherein the motherboard 12 has a dip switch 14 for identifying the panel 10.

If the motherboard 12 supports the panel A and panel B, the dip switch 14 is coupled to one general purpose input/output (abbreviated as GPIO) pin of a chip on the motherboard 12. When the panel A is electrically connected to the motherboard 12, the voltage level of the GPIO pin is the high voltage level by setting the dip switch 14, thus the motherboard receives the logic state 1 of the GPIO pin to drive the panel A. When the panel B is electrically connected to the motherboard 12, the voltage level of the GPIO pin is set to the low voltage level by the dip switch 14, thus the motherboard receives the logic state 0 of the GPIO pin to drive the panel B.

Although the engineer can utilize the dip switch 14 for the motherboard 12 to identify the type of the panel 10, incorrect setting of the dip switch 14 damages the panel 10, thus, the invention provides an identification system capable of supporting multiple types of panels 10 for reducing the probability of incorrect setting of the dip switch 14.

### BRIEF SUMMARY OF THE INVENTION

The invention provides an identification system comprising a first electronic device having a first receiving part, a connection cable suited for the first electronic device and a second electronic device. The connection cable further comprises a first connection part to connect the first receiving part and a second connection part having a first pin, a second pin and a plurality of identification pins coupled to the first pin or the second pin. The second electronic device comprises a second receiving part and an identification unit. The second receiving part for connecting to the second connection part comprises a first pin receiving part for connecting the first pin, a second pin receiving part for connecting the second pin and a plurality of identification pin receiving parts for connect the identification pins. The identification unit is coupled to the identification pin receiving parts, wherein when the first connection part is electrically connected to the first receiving part and the second connection part is electrically connected to the second receiving part, the identification unit transmits an identification data to the second electronic device according to the logic states of the identification pin receiving parts, and the second electronic device drives the first electronic device according to the identification data.

In one preferable embodiment, the first pin receiving part is coupled to a logic high level and the second pin receiving, part is, coupled to a logic low level.

The invention further provides an identification method comprising the following steps: providing a first electronic device having a first receiving part; providing a connection cable suited for the first electronic device having a first connection part and a second connection part, wherein the second connection part has a first pin, a second pin, and a plurality of identification pins; making connections to the first pin or the second pin for the identification pins; providing a second electronic device having a second receiving part and an identification unit, wherein the second receiving part has a first pin receiving part, a second pin receiving part and a plurality of identification pin receiving parts, and the identification unit is coupled to the identification pin receiving parts; when the first connection part is electrically connected to the first receiving part, and the second connection part is electrically connected to the second receiving part, the identification unit transmits an identification data to the second electronic device according to the logic states of the identification pin receiving parts, and the second electronic device drives the first electronic device according to the identification data.

In one preferable embodiment, the first pin receiving part is coupled to a logic high level and the second pin receiving part is coupled to a logic low level.

The invention further provides an identification system comprising a first electronic device having a first connection part comprising a first pin, a second pin and a plurality of identification pins coupled to the first pin or the second pin, a second electronic device having a first receiving part comprising a first pin receiving part coupled to a first voltage level to connect the first pin, a second pin receiving part coupled to a second voltage level to connect the second pin and a plurality of identification pins receiving parts coupled to the identification pins, and an identification unit coupled to the identification pins receiving part, wherein when the first connection part is electrically connected to the first receiving part, the identification unit transmits an identification data to the second electronic device according to logic states of the identification pins receiving part, and then the second electronic device drives the first electronic device according to the identification data.

In one preferable embodiment, the first voltage level is a logic high level and the second voltage level is a logic low level.

In one preferable embodiment, the identification system further comprises a connection cable to make a connection between the first electronic device and the second electronic device.

The invention further provides an identification method comprising the following steps: providing a first electronic device having a first connection part comprising a first pin, a second pin and a plurality of GPIO pins; providing a second electronic device having a first receiving part and an identification unit, wherein the first receiving part has a first pin receiving part, a second pin receiving part and a plurality of GPIO receiving parts; selecting a part of the GPIO pins to be a plurality of identification pins coupled to the first pin or the second pin; making a connection between the first pin receiving part and a first voltage level having a first logic state; making a connection between the second pin receiving part and a second voltage level having a second logic state; selecting a part of the GPIO pin receiving parts to be a plurality of identification pin receiving parts corresponded to the identification pins; making a connection between the identification pin receiving parts and the identification unit; when the first connection part is electrically connected to the first receiving part, the identification unit transmits an identification data to the second electronic device according to logic states of the identification pins receiving part, and then the second electronic device drives the first electronic device according to the identification data.

In one preferable embodiment, the method of the invention further comprises providing a connection cable to make a connection between the first electronic device and the second electronic device.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIG. 1a is a schematic diagram of a conventional identification system.

FIG. 1b is a flow chart of the invention.

FIG. 2 is a schematic diagram of an embodiment of the invention.

FIG. 3 is a table of three panels with their corresponding identification code and identification pins.

FIG. 4 is a schematic diagram of the second electronic device 20 and a connection cable suited for the panel A.

FIG. 5 is a schematic diagram of the second electronic device 20 and a connection cable suited for the panel B.

FIG. 6 is a schematic diagram of the second electronic device 20 and a connection cable suited for the panel C.

FIG. 7 is a schematic diagram of another embodiment of the invention.

### DETAILED. DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

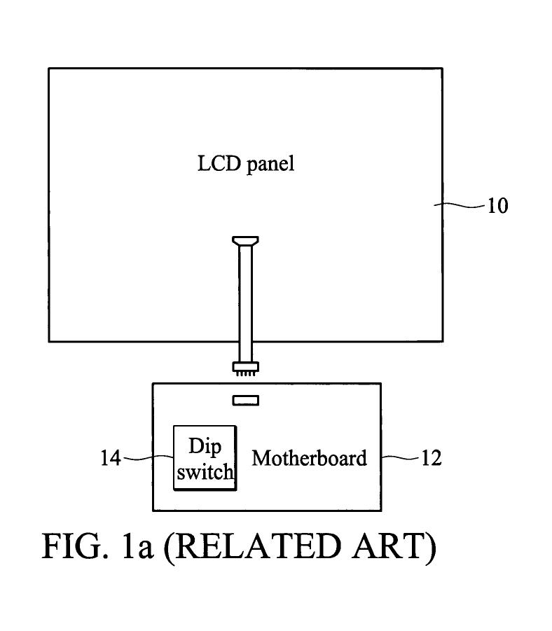

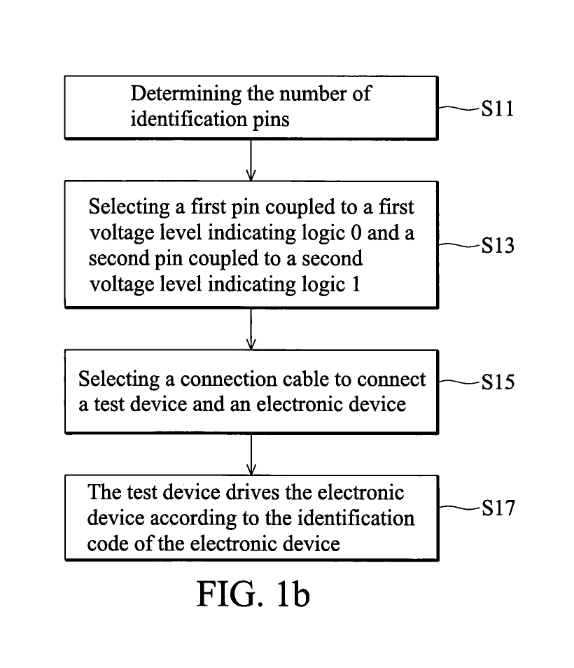

FIG. 1b is a flow chart of the invention. In step S11, the number of identification pins is determined according to the number of the types of the electronic devices need to be identified. In the embodiment of FIG. 1b, n identification pins can identify at most 2ⁿ types of electronic devices. For example, if three kinds of electronic devices need to be identified, at least two identification pins are required, and if sixteen kinds of electronic devices need to be identified, at least four identification pins are required. In step S13, the identification device provides a first pin coupled to a first voltage level indicating logic 0 and a second pin coupled to a second voltage level indicating logic 1. In step S15, a connection cable is coupled to the electronic device and the identification device, and then the identification device drives the electronic device through the connection cable.

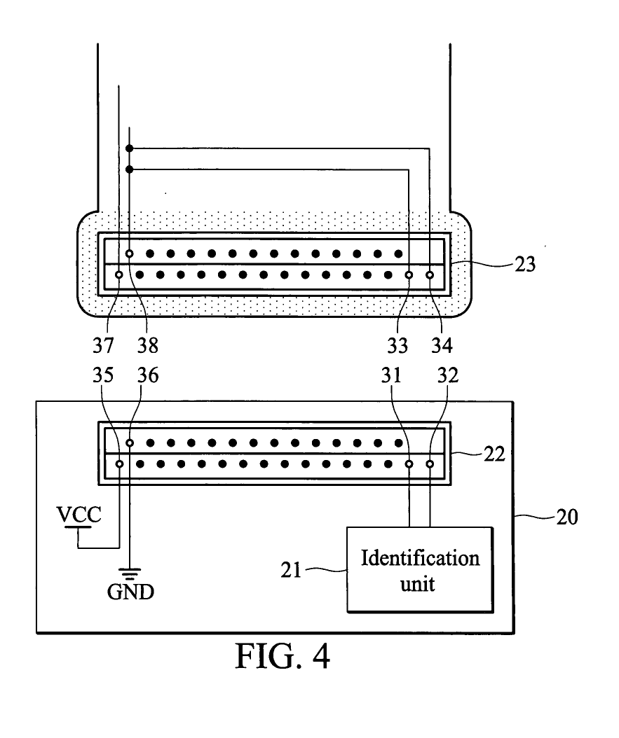

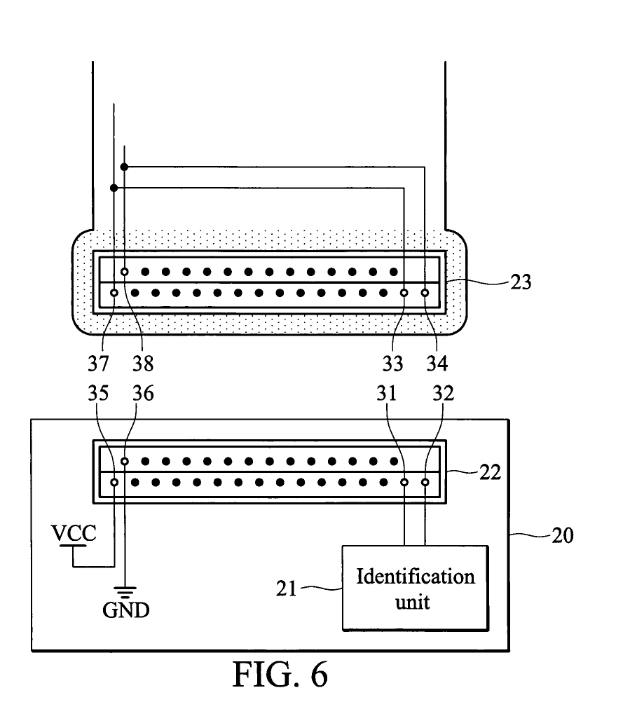

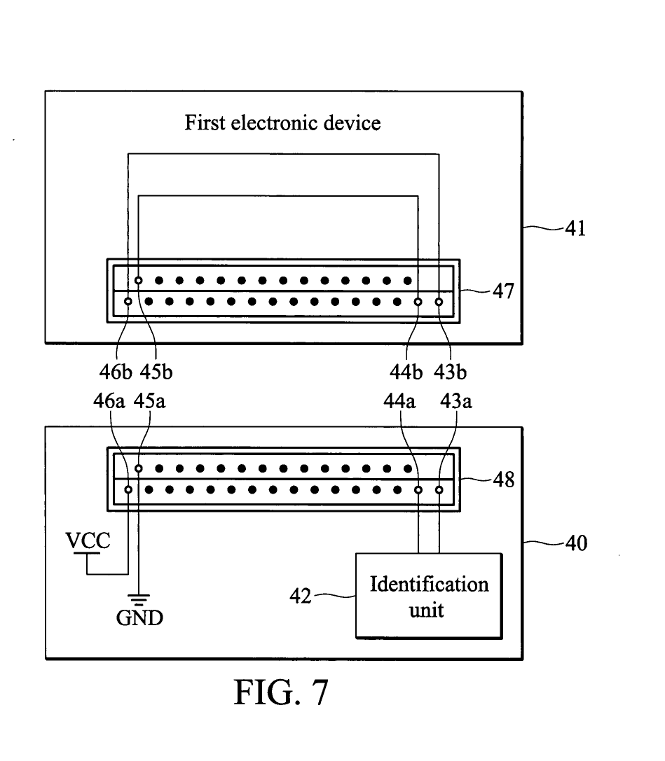

In the invention, the connection cable has two types of connection cables, one is suited for all types of electronic devices and another is only suited for a specific electronic device, wherein the connection cable only suitable for a specific electronic device comprises a plurality of identification signal lines, a first signal line and a second signal line respectively corresponding to a plurality of identification pins, a first pin and a second pin. To correctly identify the electronic device, the identification signal lines provides the identification code to the identification device when the electronic device is electrically connected to the identification device through the connection cable, thus the identification device selects the proper parameters to drive the electronic device according to the identification code. In the connection cable, the identification signal lines are connected to the first signal line or the second signal line based on the identification code of the electronic device need to be identified. In step S17, when the electronic device is electrically connected to the identification device through the connection cable, the identification device acquires the identification code of the electronic device by reading the states of the identification pins and the identification device selects the proper parameters to drive the electronic device according to the identification code. Except for the described connection cable suited for a specific electronic device (please refer to FIG. 4˜FIG. 6), the connection cable can be designed for general purposes (please refer to FIG. 7, the connection cable of FIG. 7 is for general purpose and the identification code is provided by the electronic device, such as the first electronic device 41).

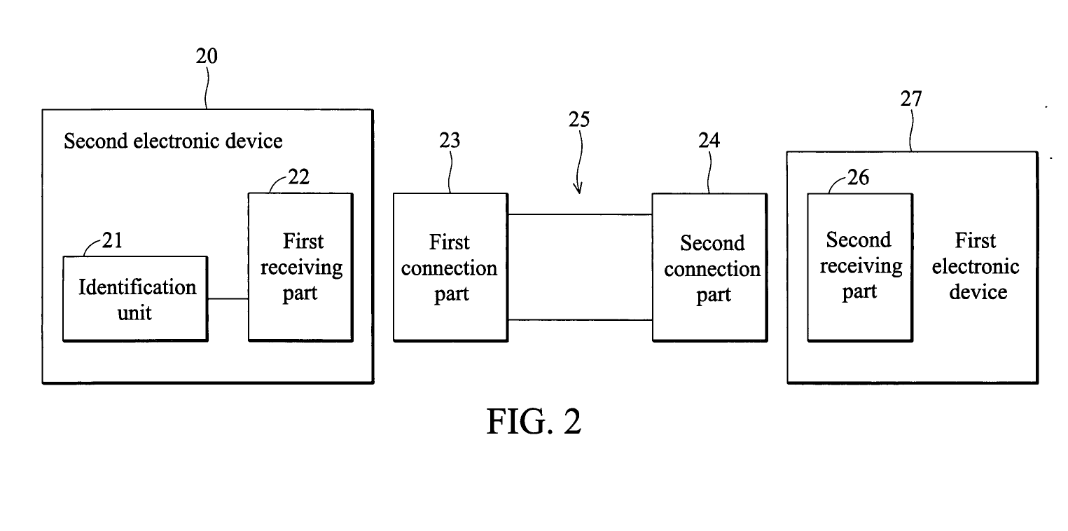

FIG. 2 is a schematic diagram of an embodiment of the invention. The first electronic device 27 has a second receiving part 26 to connect the second connection part 24 of the connection cable 25. The second electronic device 20 has a first receiving part 22 and an identification unit 21, wherein the first receiving part 22 is used to connect the first connection part 23 of the connection cable 25. The connection cable 25 has a plurality of identification lines (not shown in FIG. 2) coupled to a first signal line having a logic state 0 or a second signal line having a logic state 1 according to the identification code of the first electronic device 27. When the connection cable 25 is electrically connected to the second electronic device 20, the identification unit 21 receives the identification code from the identification lines of the connection cable 25, and the second electronic device 20 drives the first electronic device 27 according to the identification code. The described connection cable 25 is capable of providing an identification code (please refer to FIG. 4˜FIG. 6), those skilled in the art can utilize a general connection cable capable of transmitting signals and a electronic device capable of providing the identification code (please refer to the embodiment of FIG. 7, the connection cable thereof is suited for all kinds of electronic device) to achieve the same function.

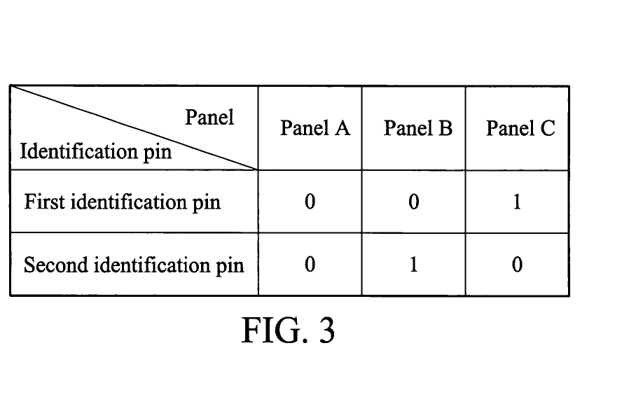

To further illustrate the invention, three exemplary kinds of panels are disclosed. Three kinds of connection cables suited for three kinds of panels are required, and two identification pins on the connection cable are required for identifying the three kinds of panels. Please refer to FIG. 3. FIG. 3 is a table of three panels with their corresponding identification codes and identification pins, wherein the panel A has an identification code [00], the panel B has an identification code [01] and the panel C has an identification code [10], and the corresponding first identification pin and second identification pin of the three respective kinds of connection cable are coupled to the logic state set [00], [01] and [10].

FIG. 4 is a schematic diagram of the second electronic device 20 and a connection cable suited for the panel A, wherein the identification code of panel A is [00]. The second electronic device 20 has a first receiving part 22 and an identification unit 21, wherein the first receiving part 22 has a first identification pin receiving part 31, a second identification pin receiving part 32, a first pin receiving part 36 and a second pin receiving part 35. The identification unit 21 is coupled to the first identification pin receiving part 31 and the second identification pin receiving part 32. The first pin receiving part 36 is coupled to a first voltage level to represent the logic state 0, and the second pin receiving part 35 is coupled to a second voltage level to represent the logic state 1.

In the first connection part 23, the first identification connection part 33 and the second identification connection part 34 are connected to the first pin 38. When the first connection part 23 is electrically connected to the first receiving part 22, the first pin 38 and the second pin 37 are respectively electrically connected to the first pin receiving part 36 and the second pin receiving part 35, and the first identification pin receiving part 31 and the second identification pin receiving part 32 are respectively electrically connected to the first identification connection part 33 and the second identification connection part 34. Thus, the first identification pin receiving part 31 and the second identification pin receiving part 32 are coupled to a first voltage level representing the logic state 0 through the connection of the first connection part 23 and the first receiving part 22. The identification unit 21 receives the identification code of the panel A, [00], according to the logic states of the first identification pin receiving part 31 and the second identification pin receiving part 32, thus the second electronic device 20 drives the panel A according to the identification code [00].

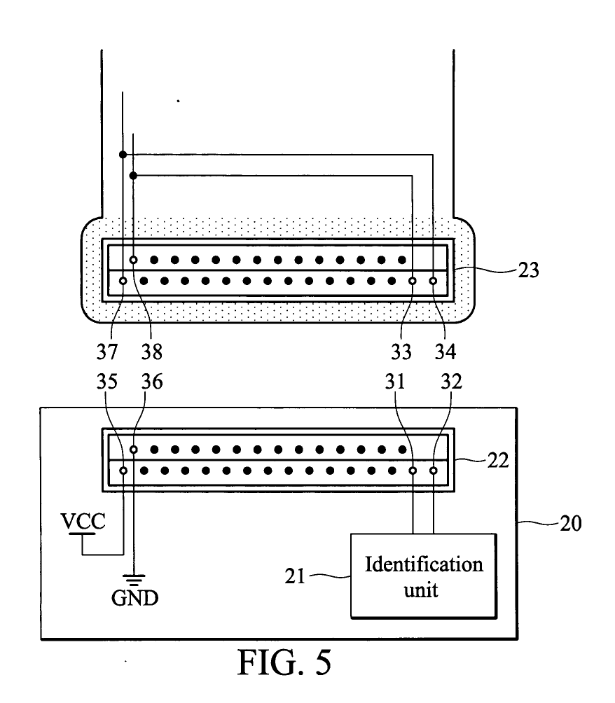

FIG. 5 is a schematic diagram of the second electronic device 20 and a connection cable suited for the panel B, wherein the identification code of panel B is [01]. Compared with the FIG. 4, the only difference in FIG. 5 is that the first identification connection part 33 is coupled to the first pin 38 of the connection cable 25 and the second identification connection part 34 is coupled to the second pin 37. Thus, the first identification pin receiving part 31 and the second identification pin receiving part 32 are respectively coupled to the first voltage level representing the logic state 0 and a second voltage level representing the logic state 1 through the connection of the first connection part 23 and the first receiving part 22. The identification unit 21 receives the identification code of the panel B, [01], according to the logic states of the first identification pin receiving part 31 and the second identification pin receiving part 32, thus the second electronic device 20 drives the panel B according to the identification code [01].

FIG. 6 is a schematic diagram of the second electronic device 20 and a connection cable suited for the panel C, wherein the identification code of panel C is [10]. Compared with the FIG. 4, the only difference of the FIG. 6 is that the first identification connection part 33 is coupled to the second pin 37 of the connection cable 25 and the second identification connection part 34 is coupled to the first pin 38. Thus, the first identification pin receiving part 31 and the second identification pin receiving part 32 are respectively coupled to the second voltage level representing the logic state 1 and a first voltage level representing the logic state 0 through the connection of the first connection part 23 and the first receiving part 22. The identification unit 21 receives the identification code of the panel C, [10], according to the logic states of the first identification pin receiving part 31 and the second identification pin receiving part 32, thus the second electronic device 20 drives the panel C according to the identification code [10].

FIG. 7 is a schematic diagram of another embodiment of the invention. In the embodiment of FIG. 7, a first electronic device 41 having an identification code [01] is provided. In FIG. 7, the second electronic device 40 has a first receiving part 48 and an identification unit 42, wherein the first receiving part 48 comprises a first identification pin receiving part 44a, a second identification pin receiving part 43a, a first pin receiving part 45a and a second pin receiving part 46a, wherein the identification unit 42 is coupled to first identification pin receiving part 44a and the second identification pin receiving part 43a, the first pin receiving part 45a is coupled to a first voltage level of the second electronic device 40 representing the logic state 0, and the second pin receiving part 46a is coupled to a second voltage level of the second electronic device 40 representing the logic state 1.

The second receiving part 47 of the first electronic device 41 comprises a first identification pin connection part 44b, a second identification pin connection part 43b, a first pin 45b and a second pin 46b, wherein the first identification pin connection part 44b and second identification pin connection part 43b are coupled to the first pin 45b and the second pin 46b of the second receiving part 47.

When the second receiving part 47 is electrically connected to the first receiving part 48 of the second electronic device 40 through a connection mean, such as the connection cable 25 of FIG. 2, the first pin 45b and the second pin 46b are respectively coupled to the first pin receiving part 45a and the second pin receiving part 46a, and the first identification pin connection part 44b and the second identification pin connection part 43b are respectively coupled to the first identification pin receiving part 44a and second identification pin receiving part 43a. Thus, the first identification pin receiving part 44a and second identification pin receiving part 43a are respectively coupled to the first voltage level representing the logic state 0 and the second voltage level representing the logic state 1 through the connection between the first receiving part 48 and the second receiving part 47. The identification unit 42 receives the identification code [01] of the first electronic device 41 according to the logic states of the first identification pin receiving part 44a and second identification pin receiving part 43a, thus the second electronic device 40 drives the first electronic device 41 according to the identification code [01].

Compared with the identification system of FIG. 2, the function of providing the identification code is designed at the connection cable in the embodiment of FIG. 2, thus, the connection cable is only suited for one kind of electronic device. In the embodiment of FIG. 7, the function of providing the identification code is designed at an electronic device, such as the first electronic device 41 of FIG. 7, and the connection cable is only for transmitting signals. Thus, the connection cable between the electronic device and the identification device, such as the second electronic device 40 is for general purposes.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An identification system, comprising:
a first electronic device having a first receiving part;
a connection cable suited for the first electronic device, comprising:
a first connection part to connect the first receiving part; and
a second connection part, comprising:
a first pin;
a second pin; and
a plurality of identification pins coupled to the first pin or the second pin; and
a second electronic device, comprising:
a second receiving part for connecting to the second connection part, comprising:
a first pin receiving part to connect the first pin;
a second pin receiving part to connect the second pin; and
a plurality of identification pins receiving parts to connect the identification pins; and
an identification unit coupled to the identification pin receiving parts, wherein when the first connection part is electrically connected to the first receiving part and the second connection part is electrically connected to the second receiving part, the identification unit transmits an identification data to the second electronic device according to the logic states of the identification pin receiving parts, and the second electronic device drives the first electronic device according to the identification data.

2. The identification system as claimed in claim 1, wherein the first pin receiving part is coupled to a logic high level.

3. The identification system as claimed in claim 1, wherein the second pin receiving part is coupled to a logic low level.

4. The identification system as claimed in claim 1, wherein the first electronic device is an LCD panel.

5. An identification method, comprising:
providing a first electronic device having a first receiving part;
providing a connection cable suited for the first electronic device having a first connection part and a second connection part, wherein the second connection part has a first pin, a second pin, and a plurality of identification pins;
making connections to the first pin or the second pin for the identification pins;
providing a second electronic device having a second receiving part and an identification unit, wherein the second receiving part has a first pin receiving part, a second pin receiving part and a plurality of identification pin receiving parts, and the identification unit is coupled to the identification pin receiving parts; and
when the first connection part is electrically connected to the first receiving part, and the second connection part is electrically connected to the second receiving part, the identification unit transmits an identification data to the second electronic device according to the logic states of the identification pin receiving parts, and the second electronic device drives the first electronic device according to the identification data.

6. The identification method as claimed in claim 5, wherein the first pin receiving part is coupled to a logic high level.

7. The identification method as claimed in claim 5, wherein the second pin receiving part is coupled to a logic low level.

8. An identification system, comprising:
a first electronic device having a first connection part, comprising:
a first pin;
a second pin; and
a plurality of identification pins coupled to the first pin or the second pin; and
a second electronic device comprising:
a first receiving part for connecting to the first connection part, comprising:
a first pin receiving part coupled to a first voltage level to connect the first pin;
a second pin receiving part coupled to a second voltage level to connect the second pin; and
a plurality of identification pins receiving parts coupled to the identification pins;
an identification unit coupled to the identification pin receiving parts, wherein when the first connection part is electrically connected to the first receiving part, the identification unit transmits an identification data to the second electronic device according to logic states of the identification pin receiving parts, and then the second electronic device drives the first electronic device according to the identification data.

9. The identification system as claimed in claim 8, further comprising a connection cable to make a connection between the first electronic device and the second electronic device.

10. The identification system as claimed in claim 8, wherein the first voltage level is a logic high level.

11. The identification system as claimed in claim 8, wherein the second voltage level is a logic low level.

12. An identification method, comprising:
providing a first electronic device having a first connection part comprising a first pin, a second pin and a plurality of GPIO pins;
providing a second electronic device having a first receiving part and an identification unit, wherein the first receiving part has a first pin receiving part, a second pin receiving part and a plurality of GPIO receiving parts;
selecting a part of the GPIO pins to be a plurality of identification pins coupled to the first pin or the second pin;
making a connection between the first pin receiving part and a first voltage level having a first logic state;
making a connection between the second pin receiving part and a second voltage level having a second logic state;
selecting a part of the GPIO pin receiving parts to be a plurality of identification pin receiving parts corresponded to the identification pins; and
making a connection between the identification pin receiving parts and the identification unit;
when the first connection part is electrically connected to the first receiving part, the identification unit transmits an identification data to the second electronic device according to logic states of the identification pin receiving parts, and then the second electronic device drives the first electronic device according to the identification data.

13. The method as claimed in claim 12, further comprising:
providing a connection cable to make a connection between the first electronic device and the second electronic device.

14. The method as claimed in claim 12, wherein the first logic state is logic 1.

15. The method as claimed in claim 12, wherein the second logic state is logic 0.
